(19) United States
(12) Patent Application Publication
(10) Pub. No.: US 2026/0154586 A1
(43) Pub. Date: Jun. 4, 2026

(54) QUANTUM COMPUTER AND METHOD FOR GENERATING ANSATZ CIRCUIT

(71) Applicant: Hon Hai Precision Industry Co., Ltd., New Taipei City (TW)

(72) Inventors: Chun-Tse Li, New Taipei City (TW); Tze Tzen Ong, New Taipei City (TW); Ming-Chien Hsu, New Taipei City (TW); Hsin Lin, New Taipei City (TW); Min-Hsiu Hsieh, New Taipei City (TW)

(73) Assignee: Hon Hai Precision Industry Co., Ltd., New Taipei City (TW)

(21) Appl. No.: 18/961,458

(22) Filed: Nov. 27, 2024

Related U.S. Application Data
(60) Provisional application No. 63/602,666, filed on Nov. 27, 2023.

(51) Int. Cl. G06N 10/20; G06N 10/40; G06N 10/60

(52) U.S. Cl. CPC G06N 10/20; G06N 10/40; G06N 10/60

(57) ABSTRACT

A quantum computer and a method for generating an ansatz circuit are provided. The method includes: defining, by a processor, a scattering matrix according to an interacting term of a Hamiltonian function based on Gellman-Low theorem; generating, by the processor, a variational form of the scattering matrix; generating, by the processor and a quantum processor, an operator of the ansatz circuit according to the variational form; and performing, by the quantum processor, a quantum operation according to the operator to process input data.

### CROSS-REFERENCE TO RELATED APPLICATION

This application claims the priority benefits of U.S. provisional application Ser. No. 63/602,666, filed on Nov. 27, 2023. The entirety of the above-mentioned patent application is hereby incorporated by reference herein and made a part of this specification.

### BACKGROUND

### Technical Field

The disclosure relates to a quantum computer technology, and in particular to a quantum computer and a method for generating an ansatz circuit.

### Description of Related Art

The variational quantum eigensolver (VQE) may use a quantum computer to calculate a ground state energy of a quantum system. Currently, the VQE may include the following algorithms for generating an ansatz circuit: quantum approximate optimization algorithm (QAOA), variational Hamiltonian ansatz (VHA), or unitary coupled-cluster singles and doubles (UCCSD).

However, the above algorithms have some shortcomings. For example, most algorithms can only approximate ground state wave functions of quantum systems. Approximate results contain less excited state information. In addition, functions used by the algorithms increase calculational complexity. For example, the calculational complexity of the UCCSD and deformed iterative qubit coupled cluster (iQCC) thereof is O(N⁴), where N is the number of eigenstates. In addition, due to the non-interacting term of the Hamiltonian function, high-frequency oscillations occur in the variational wave function, causing slower convergence of optimization. In addition, some algorithms have very large operator pool sizes, thereby causing increased depth of quantum circuits.

### SUMMARY

The disclosure provides a quantum computer and a method for generating an ansatz circuit, which can generate the ansatz circuit with advantages such as low complexity.

A quantum computer for generating an ansatz circuit of the disclosure includes a quantum processor and a processor. The processor is coupled to the quantum processor. The processor defines a scattering matrix according to an interacting term of a Hamiltonian function based on Gellman-Low theorem. The processor generates a variational form of the scattering matrix. The processor and the quantum processor generate an operator of the ansatz circuit according to the variational form. The quantum processor performs a quantum operation according to the operator to process input data.

In an embodiment of the disclosure, the variational form of the scattering matrix is

$${\prod }_{i} {e}^{{θ}_{i} ( {O}_{{k}_{1} {k}_{2} q} - {O}_{{k}_{1} {k}_{2} q}^{†} )} ,$$

where i is a positive integer, θᵢ is an i-th variational parameter, Oₖ_{₁}ₖ_{₂}_{q} is an operator corresponding to incident momentums k₁ and k₂ of two-body scattering and a before and after scattering momentum difference value q, and

$${O}_{{k}_{1} {k}_{2} q}^{†}$$

is a conjugate transpose matrix of Oₖ_{₁}ₖ_{₂}_{q}.

In an embodiment of the disclosure, the processor obtains an operator pool. The processor uses the quantum processor to perform partial differentiation of multiple variational parameters on the Hamiltonian function to obtain multiple gradients respectively corresponding to the variational parameters. The gradients include a maximum gradient. The processor selects the operator from the operator pool according to the maximum gradient.

In an embodiment of the disclosure, the processor generates a threshold according to the maximum gradient. In response to a gradient corresponding to the operator being greater than or equal to the threshold, the processor selects the operator from the operator pool.

In an embodiment of the disclosure, the processor selects a first operator and a second operator from the operator pool. The first operator corresponds to a first gradient, and the second operator corresponds to a second gradient. The processor sequentially configures the first operator and the second operator in the ansatz circuit according to the first gradient and the second gradient.

In an embodiment of the disclosure, in response to the first gradient being greater than the second gradient, the processor prioritizes configuring the first operator, and then configures the second operator.

In an embodiment of the disclosure, the processor configures the operator in the ansatz circuit to update the ansatz circuit, and optimizes the variational parameter according to the ansatz circuit. In response to an absolute value of the maximum gradient being less than a gradient threshold, the processor transmits the ansatz circuit to the quantum processor to perform the quantum operation.

In an embodiment of the disclosure, in response to the absolute value being greater than or equal to the gradient threshold, the processor updates the ansatz circuit.

A method for generating an ansatz circuit of the disclosure includes: defining, by a processor, a scattering matrix according to an interacting term of a Hamiltonian function based on Gellman-Low theorem; generating, by the processor, a variational form of the scattering matrix; generating an operator of the ansatz circuit, by the processor and a quantum processor, according to the variational form; and performing a quantum operation, by the quantum processor, according to the operator to process input data.

Based on the above, the quantum computer of the disclosure may define the variational form of the scattering matrix based on the Gellman-Low theorem, and may calculate the gradient of each operator in the operator pool based on the variational form. The quantum computer may select the operators with greater influence on the ansatz circuit according to the gradient, and may sequentially configure the operators in the ansatz circuit according to the gradient. After performing multiple iterations until the operators have converged, the quantum computer may generate the final version of the ansatz circuit. The quantum processor may perform the quantum operation according to the ansatz circuit to solve for the eigenstate of the Hamiltonian function.

### BRIEF DESCRIPTION OF THE DRAWINGS

FIG. 1 is a schematic diagram of a quantum computer for generating an ansatz circuit according to an embodiment of the disclosure.

FIG. 2 is a flowchart of a method for generating an ansatz circuit according to an embodiment of the disclosure.

FIG. 3 is a flowchart of a method for generating an ansatz circuit according to an embodiment of the disclosure.

### DESCRIPTION OF THE EMBODIMENTS

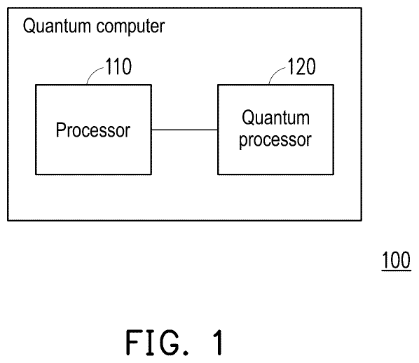

FIG. 1 is a schematic diagram of a quantum computer 100 for generating an ansatz circuit according to an embodiment of the disclosure. The quantum computer 100 may include a processor 110 and a quantum processor 120, wherein the processor 110 may be coupled to the quantum processor 120. The processor 110 may be a classical processor.

The processor 110 is, for example, a central processing unit (CPU), other programmable general-purpose or specific-purpose micro control units (MCU), microprocessors, digital signal processors (DSP), programmable controllers, application specific integrated circuits (ASIC), graphics processing units (GPU), image signal processors (ISP), image processing units (IPU), arithmetic logic units (ALU), complex programmable logic devices (CPLD), field programmable gate arrays (FPGA), other similar components, or a combination of the above components.

In an embodiment, the processor 110 may be coupled to a storage medium or a transceiver. The processor 110 accesses and executes multiple modules stored in the storage medium to perform various functions of the quantum computer 100. The processor 110 may communicate with an external electronic device through the transceiver to receive or transmit data. The storage medium is, for example, any type of fixed or removable random access memory (RAM), read-only memory (ROM), flash memory, hard disk drive (HDD), solid state drive (SSD), similar components, or a combination of the above components.

The ansatz circuit may be configured with one or more quantum gates. The quantum gate is formed by operators and may be configured to change the behavior (for example, a rotation angle or a phase) of a qubit. The quantum processor 110 may use the qubit to perform a quantum operation such as quantum superposition or quantum entanglement based on the ansatz circuit. The quantum operation may change the quantum state, such as an initial state, an incident state, a final state, an intermediate state, an eigenstate, a superposition state, or an entangled state of the qubit.

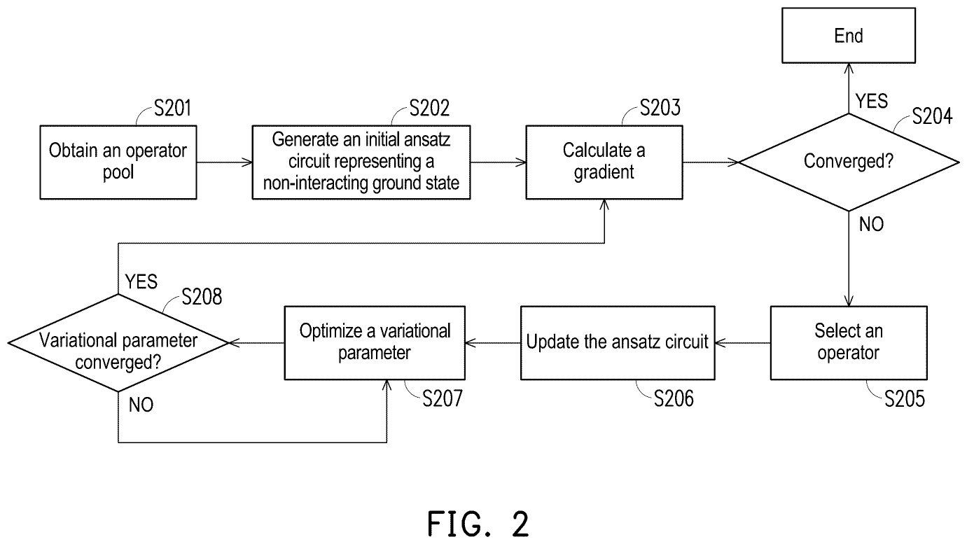

FIG. 2 is a flowchart of a method for generating an ansatz circuit according to an embodiment of the disclosure, wherein the generation method may be implemented by the quantum computer 100 shown in FIG. 1.

In step S201, the processor 110 may obtain a Hamiltonian function H. For example, the processor 110 may receive the Hamiltonian function H that a user intends to solve from an external electronic device through the transceiver. The processor 110 may obtain an operator pool based on the Hamiltonian function H.

Specifically, the total energy of a quantum system is as shown in formula (1), where H is the Hamiltonian function based on the Hubbard model, H₀ is a non-interacting term, Hᵢₙₜ is an interacting term, g is a coupling constant, ϵₖ is a dispersion relation of a momentum k, μ is a chemical potential, c_{\vec{k},σ} is an annihilation operator,

$${c}_{\vec{k} , σ}^{†}$$

is a conjugate transpose matrix of c_{\vec{k},σ}, U is an interaction strength, k₁ and k₂ are incident momentums of two-body scattering, and Oₖ_{₁}ₖ_{₂}_{q} is an operator corresponding to the incident momentums k₁ and k₂ of two-body scattering and a before and after scattering momentum difference value q.

$$H = {H}_{0} + {gH}_{int} \qquad ( 1 )$$

$${H}_{0} = {\sum }_{\vec{k} , σ} ( {ϵ}_{k} - μ ) {c}_{\vec{k} , σ}^{†} {c}_{\vec{k} , σ} \qquad ( 1 )$$

$${gH}_{int} = {H}_{U} = U {\sum }_{{k}_{1} , {k}_{2} , q} {O}_{{k}_{1} , {k}_{2} , q} \qquad ( 1 )$$

In an interaction picture, a wave function and operators of the quantum system are shown in formula (2), where |Ψ_{G}(t) [symbol] is a ground state vector of the wave function at time t, |Ψ_{G}( ) [symbol] is a ground state vector of the wave function at time t=0, and Ô(t) is the operator at time t.

$$\vert {Ψ}_{G} ( t ) 〉 = {e}^{{iH}_{0} t} {e}^{- Ht} \vert {Ψ}_{G} ( 0 ) 〉 \qquad ( 2 )$$

$$\hat{O} ( t ) = {e}^{{iH}_{0} t} \hat{O} ( t ) {e}^{- {iH}_{0} t} \qquad ( 2 )$$

In the interaction picture, an evolution process of the quantum system from the initial state to the final state is as shown in the Gellman-Low theorem of formula (3), where is |Ψ_{G}(0) [symbol] the ground state vector of the wave function at t=0, S(0, −∞, g) is a scattering matrix when the coupling constant is equal to g from time t=0 to t=−∞, and |Ψ₀ [symbol] is a ground state vector of H₀.

$$\vert {Ψ}_{g} ( 0 ) 〉 = S ( 0 , - ∞ , g ) \vert {Ψ}_{0} 〉 \qquad ( 3 )$$

The processor 110 may define the scattering matrix as shown in formula (4) based on the Gellman-Low theorem, where S(t, t′, g) is the scattering matrix when the coupling constant is g from time t to time t′, T is a time ordered operator, and Ĥᵢₙₜ(t₁) is an interacting term in the interaction picture at time t₁.

$$S ( t , {t}^{′} , g ) = {Tr}^{[ - i {\int }_{{t}_{1} = {t}^{′}}^{t} {dt}_{1} g {\hat{H}}_{int} ( {t}_{1} ) ]} \qquad ( 4 )$$

The processor 110 may perform Jordan-Wigner (JW) transformation on any real symmetric Hamiltonian function (including the Hubbard model and most time-reversal symmetric systems). Under JW basis representation, the Hamiltonian function remains a real symmetric matrix, and the ground state wave function |Φ₀ [symbol] is a real vector.

The processor 110 may define a variational form S(\vec{θ}) of the scattering matrix S(t, t′, g) as shown in formula (5) based on the scattering matrix S(t, t′, g) as shown in formula (4), where i is an index of an operator in the operator pool and i is a positive integer, θᵢ is an i-th variational parameter, Oₖ_{₁}ₖ_{₂}_{q} is the operator corresponding to the incident momentums k₁ and k₂ of two-body scattering and the before and after scattering momentum difference value q, and

$${O}_{{k}_{1} {k}_{2} q}^{†}$$

is a conjugate transpose matrix of Oₖ_{₁}ₖ_{₂}_{q}. An initial value of the variational parameter θᵢ may be 0.

$$S ( \vec{θ} ) = {\prod }_{i} {e}^{{θ}_{i} ( {O}_{{k}_{1} {k}_{2} q} - {O}_{{k}_{1} {k}_{2} q}^{†} )} \qquad ( 5 )$$

The processor 110 may obtain the operator pool corresponding to the Hubbard model. The operator Oₖ_{₁}_{,k}_{₂}_{,q} in the operator pool satisfies formula (6), where

$${c}_{{k}_{1} + q , ↑}^{†}$$

is an operator that creates a quantum with a momentum (k₁+q) and spins up,

$${c}_{{k}_{2} - q , ↓}^{†}$$

is an operator that creates a quantum with a momentum (k₂−q) and spins down, cₖ_{₂}_{,↓} is an operator that annihilates a quantum with a momentum k₂ and spins down, and cₖ_{₁}_{,↑} is an operator that annihilates a quantum with a momentum k₁ and spins up.

$${H}_{U} = U {\sum }_{{k}_{1} , {k}_{2} , q} {O}_{{k}_{1} , {k}_{2} , q} \qquad ( 6 )$$

$${O}_{{k}_{1} , {k}_{2} , q} = {c}_{{k}_{1} + q , ↑}^{†} {c}_{{k}_{2} - q , ↓}^{†} {c}_{{k}_{2} , ↓} {c}_{k 1 , ↑} \qquad ( 6 )$$

The processor 110 may define Aₖ_{₁}_{,k}_{₂}_{,q} according to the operator Oₖ_{₁}_{,k}_{₂}_{,q}, as shown in formula (7).

$${A}_{{k}_{1} , {k}_{2} , q} = {O}_{{k}_{1} , {k}_{2} , q} - {O}_{{k}_{1} , {k}_{2} , q}^{†} \qquad ( 7 )$$

After obtaining Aₖ_{₁}_{,k}_{₂}_{,q}, the variational form S(\vec{θ}) may be equivalent to formula (8). Uₖ_{₁}_{,k}_{₂}_{,q}(θᵢ) corresponds to a quantum logic gate composed of the operator Aₖ_{₁}_{,k}_{₂}_{,q} and corresponds to the variational parameter θᵢ to be optimized, wherein S(\vec{θ}) represents updating a set of all selected logic gates set on the ansatz circuit.

$$S ( \vec{θ} ) = {\prod }_{i} {U}_{{k}_{1} , {k}_{2} , q} ( {θ}_{i} ) \qquad ( 8 )$$

$${U}_{{k}_{1} , {k}_{2} , q} ( {θ}_{i} ) = {e}^{{θ}_{i} {A}_{{k}_{1} , {k}_{2} , q}} = 1 + sin {θ}_{i} ( {O}_{{k}_{1} , {k}_{2} , q} - {O}_{{k}_{1} , {k}_{2} , q}^{†} ) + ( cos {θ}_{i} - 1 ) ( {O}_{{k}_{1} , {k}_{2} , q} {O}_{{k}_{1} , {k}_{2} , q}^{†} + {O}_{{k}_{1} , {k}_{2} , q}^{†} {O}_{{k}_{1} , {k}_{2} , q} ) \qquad ( 8 )$$

In step S202, the processor 110 may generate an initial ansatz circuit representing a non-interacting ground state. The processor 110 may generate a ground state quantum circuit corresponding to the non-interacting term as the initial ansatz circuit.

In step S203, the processor 110 may calculate the gradient of the operator. In an embodiment, before performing step S208, the processor 110 may select one or more operators from the operator pool, and calculate the gradient of each operator. In an embodiment, after performing step S208, the processor 110 may calculate the gradient of each operator configured for the ansatz circuit in step S203, wherein the number of operators configured for the ansatz circuit may be less than the number of all operators in the operator pool.

Specifically, the processor 110 may use the quantum processor 120 to perform partial differentiation of multiple variational parameters on the Hamiltonian function H to respectively obtain multiple gradients xₖ_{₁}_{,k}_{₂}_{,q} corresponding to the variational parameters, as shown in formula (9), where [symbol] Ψ(θ)|H|Ψ(θ) [symbol] represents using the quantum processor 120 to perform measurement on the Hamiltonian function H, and [symbol] Ψ(θ)|[H, Aₖ_{₁}_{,k}_{₂}_{,q}]|Ψ(θ) [symbol] represents using the quantum processor 120 to perform measurement on the Hamiltonian function H corresponding to Aₖ_{₁}_{,k}_{₂}_{,q}.

$${x}_{{k}_{1} , {k}_{2} , q} ≡ \frac{\partial {〈 H 〉}_{θ}}{\partial {θ}_{{k}_{1} , {k}_{2} , q}} = \frac{\partial 〈 Ψ ( θ ) \vert H \vert Ψ ( θ ) 〉}{\partial {θ}_{{k}_{1} , {k}_{2} , q}} = 〈 Ψ ( θ ) \vert [ H , {A}_{{k}_{1} , {k}_{2} , q} ] \vert Ψ ( θ ) 〉 \qquad ( 9 )$$

In step S204, the processor 110 may determine whether the operator has converged according to the gradient of the operator. The ansatz circuit is configured with operators that may be updated, wherein the operators may be configured to form the quantum gate on the ansatz circuit. It is assumed that the gradient of the operator with the largest gradient in the current ansatz circuit is y. If the absolute value of y is less than a gradient threshold, the processor 110 may determine that the operator on the ansatz circuit has converged, thereby deciding to end the process. The processor 110 may transmit information such as the current ansatz circuit and the optimized variational parameter to the quantum processor 120. The quantum processor 120 may perform a quantum operation (such as calculating an eigenstate of the Hamiltonian function) based on the information such as the ansatz circuit (or the operator) and the variational parameter. On the other hand, if the absolute value of y is greater than or equal to the gradient threshold, the processor 110 may determine that the operator on the ansatz circuit has not yet converged, and perform step S205 again.

It should be noted that in the first execution of step S204, the operator on the initial ansatz circuit has not yet been updated. The processor 110 cannot determine whether the operator on the ansatz circuit has converged. Therefore, the processor 110 may skip the first execution of step S204, and perform step S205.

In step S205, the processor 110 may select an operator from the operator pool. Specifically, after obtaining the gradient of each operator in the operator pool, the processor 110 may select the maximum gradient, and decide a threshold according to the maximum gradient. The processor 110 may select operators whose gradients are greater than or equal to the threshold from the operator pool, as shown in formula (10), where

$${max}_{{k}_{1} , {k}_{2} , q} \vert {x}_{{k}_{1} , {k}_{2} , q} \vert$$

is the maximum gradient, 0<r<1 and r is a positive number (for example, r=0.1), and

$$r \cdot {max}_{{k}_{1} , {k}_{2} , q} \vert {x}_{{k}_{1} , {k}_{2} , q} \vert$$

is the threshold. In other words, the processor 110 may select an operator Oₖ_{₁}_{,k}_{₂}_{,q} corresponding to Aₖ_{₁}_{,k}_{₂}_{,q} conforming to formula (10) from the operator pool. The operator Oₖ_{₁}_{,k}_{₂}_{,q} (or Aₖ_{₁}_{,k}_{₂}_{,q}) selected by the processor 110 has a significant impact on the result of the quantum operation.

$$\{ {A}_{{k}_{1} , {k}_{2} , q} \vert \vert {x}_{{k}_{1} , {k}_{2} , q} \vert \geq r \cdot {max}_{{k}_{1} , {k}_{2} , q} \vert {x}_{{k}_{1} , {k}_{2} , q} \vert \} \qquad ( 10 )$$

In step S206, the processor 110 may update the ansatz circuit according to the selected one or more operators. In an embodiment, the processor 110 may sequentially configure multiple operators on the ansatz circuit according to the gradients of the operators. The initial value of the variational parameter θᵢ of the operator initially configured on the ansatz circuit may be 0. For example, it is assumed that the selected operators include a first operator with a first gradient and a second operator with a second gradient. If the first gradient is greater than the second gradient, the processor 110 may prioritize configuring the first operator on the ansatz circuit, and then configure the second operator on the ansatz circuit. In other words, the greater the gradient of an operator, the higher the priority of the operator being configured on the ansatz circuit. The smaller the gradient of an operator, the lower the priority of the operator being configured on the ansatz circuit.

After completing the update of the ansatz circuit, in step S207, the processor 110 may optimize the variational parameter corresponding to the ansatz circuit according to the ansatz circuit based on the optimization algorithm. The optimization algorithm may be decided by the user according to requirements and is not limited by the disclosure.

In step S208, during the process of optimizing the variational parameter, the processor 110 may determine whether the variational parameter θᵢ has converged. If the variational parameter θᵢ has not yet converged, the processor 110 performs step S207 to continue optimization. If the variational parameter θᵢ has converged, the processor 110 may complete optimization, and perform step S203.

After completing the process of FIG. 2 and generating the final ansatz circuit, the processor 110 may transmit configurations of the ansatz circuit to the quantum processor 120, wherein the configurations may include information such as the ansatz circuit, the operator on the ansatz circuit, and the optimized variational parameter corresponding to the ansatz circuit. The quantum processor 120 may perform the quantum operation according to the operator and the variational parameter on the ansatz circuit to process input data. For example, the quantum processor 120 may perform the quantum operation according to the ansatz circuit to solve the eigenstate of the Hamiltonian function H.

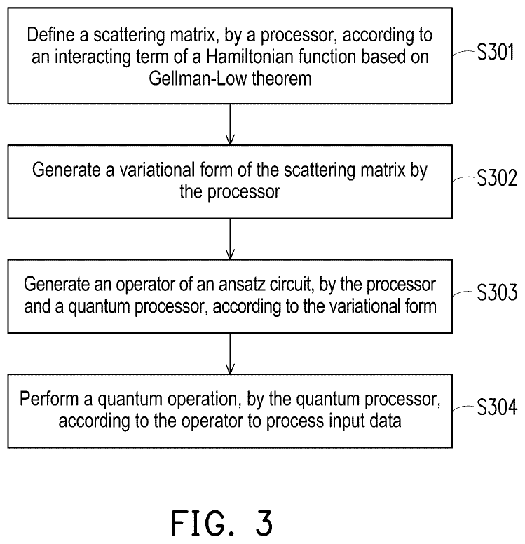

FIG. 3 is a flowchart of a method for generating an ansatz circuit according to an embodiment of the disclosure, wherein the method may be implemented by the quantum computer 100 shown in FIG. 1. In step S301, a scattering matrix is defined, by a processor, according to an interacting term of a Hamiltonian function based on Gellman-Low theorem. In step S302, a variational form of the scattering matrix is generated by the processor. In step S303, an operator of an ansatz circuit is generated, by the processor and a quantum processor, according to the variational form. In step S304, a quantum operation is performed, by the quantum processor, according to the operator to process input data.

In summary, the disclosure provides a new VQE architecture and method. Compared with the traditional VQE architecture, the perturbative interaction picture-based method of the disclosure performs order-by-order approximation on the S matrix to accelerate initial convergence. The method may select the appropriate parameter to further improve convergence. Compared with the operator pool of the UCCSD, the operator pool of the disclosure is smaller in size, which reduces the depth of the quantum circuit. Compared with the UCCSD which only includes information of single excitation and double excitation, the output generated by the disclosure may include information of all possible excitations.

What is claimed is:

1. A quantum computer for generating an ansatz circuit, comprising:
a quantum processor; and
a processor, coupled to the quantum processor, wherein
the processor defines a scattering matrix according to an interacting term of a Hamiltonian function based on Gellman-Low theorem;
the processor generates a variational form of the scattering matrix;
the processor and the quantum processor generate an operator of the ansatz circuit according to the variational form; and
the quantum processor performs a quantum operation according to the operator to process input data.

2. The quantum computer according to claim 1, wherein the variational form of the scattering matrix is
$${\prod }_{i} {e}^{{θ}_{i} ( {O}_{{k}_{1} {k}_{2} q} - {O}_{{k}_{1} {k}_{2} q}^{†} )} ,$$
where i is a positive integer, θᵢ is an i-th variational parameter, Oₖ_{₁}ₖ_{₂}_{q} is an operator corresponding to incident momentums k₁ and k₂ of two-body scattering and a before and after scattering momentum difference value q, and
$${O}_{{k}_{1} {k}_{2} q}^{†}$$
is a conjugate transpose matrix of Oₖ_{₁}ₖ_{₂}_{q}.

3. The quantum computer according to claim 2, wherein:
the processor obtains an operator pool;
the processor uses the quantum processor to perform partial differentiation of a plurality of variational parameters on the Hamiltonian function to obtain a plurality of gradients respectively corresponding to the variational parameters, wherein the gradients comprise a maximum gradient; and
the processor selects the operator from the operator pool according to the maximum gradient.

4. The quantum computer according to claim 3, wherein:
the processor generates a threshold according to the maximum gradient; and
in response to a gradient corresponding to the operator being greater than or equal to the threshold, the processor selects the operator from the operator pool.

5. The quantum computer according to claim 3, wherein:
the processor selects a first operator and a second operator from the operator pool, wherein the first operator corresponds to a first gradient, and the second operator corresponds to a second gradient; and
the processor sequentially configures the first operator and the second operator in the ansatz circuit according to the first gradient and the second gradient.

6. The quantum computer according to claim 5, wherein:
in response to the first gradient being greater than the second gradient, the processor prioritizes configuring the first operator, and then configures the second operator.

7. The quantum computer according to claim 3, wherein:
the processor configures the operator in the ansatz circuit to update the ansatz circuit, and optimizes the variational parameter according to the ansatz circuit, wherein
in response to an absolute value of the maximum gradient being less than a gradient threshold, the processor transmits the ansatz circuit to the quantum processor to perform the quantum operation.

8. The quantum computer according to claim 7, wherein:
in response to the absolute value being greater than or equal to the gradient threshold, the processor updates the ansatz circuit.

9. A method for generating an ansatz circuit, comprising:
defining, by a processor, a scattering matrix according to an interacting term of a Hamiltonian function based on Gellman-Low theorem;
generating, by the processor, a variational form of the scattering matrix;
generating an operator of the ansatz circuit, by the processor and a quantum processor, according to the variational form; and
performing a quantum operation, by the quantum processor, according to the operator to process input data.
